(19) United States
(12) Patent Application Publication
(10) Pub. No.: US 2012/0229714 A1
(43) Pub. Date: Sep. 13, 2012

(54) Multifunction digital utility unit with the next generation multifunctional TV set

(75) Inventor: Qiuhang Qian, Marble Falls, TX (US)

(73) Assignee: Qiuhang Richard Qian, Marble Falls, TX (US)

(21) Appl. No.: 13/068,575

(22) Filed: Aug. 8, 2011

Related U.S. Application Data
(60) Provisional application No. 61/449,912, filed on Mar. 7, 2011.

(51) Int. Cl. H04N 5/64

(52) U.S. Cl. 348/836; 348/E05.128

(57) ABSTRACT

The revolutionary next generation multifunctional TV set with the multifunction digital utility unit has been invented. The user can do many things both on the TV Set and the multifunctional utility unit. The TV set is designed in the range between 20″ up to 100″. The unit has three different sizes “10”, “13” and “15”. Both the TV set and the utility unit contain hardware, software and accessories. The hardware includes mother board, CPU, memory, kinescope, drives, other circuit boards and parts. The materials for making the TV set and the utility unit will be silicon, tin, zinc, gold, silver, plastic, steel and aluminum. The software will be developed using different languages with different development tools. The development languages contain logic rules, packages, procedures, triggers along with other development tools. The operating of the multifunctional TV set and the utility unit will experience the stages of turning on and off, navigation and execution. It is controlled by the utility unit. When the events happen, triggers are fired, the results will happen on the TV or on the utility unit screen.

Brand new multifunction digital utility unit with the next generation multifunctional TV set has been invented. They will be easy to use, carried and light weighted. People can watch TV wirelessly on both of them. The TV set is powered by standard 110v and 220v, internal battery as well as external battery. The whole set consists of three parts: the TV set, the multifunctional utility unit and accessories. The multifunctional utility unit is powered by the lithium battery and can be rechargeable. The TV set can be used 1). to watch TV indoor and outdoor; 2). as a computer; 3). to play music; 4). to watch movie; 5). to listen to the radio; 6). to make and receive phone call; 7). to surf the interne; 8). to play games; 9). as a digital clock with alarm 10). as a calendar; 11). to sing; 12). as a compass; 13). as a GPS; 14). for video conversation; 15). to show pictures and video; 16). to upload and to do other things. The multifunctional utility unit can be used to do as many things as the TV can do. Both of them are built with hardware parts, components and software programs.

There are two switches on the multifunctional utility unit. The first one is for moving the screen cover of the TV set. The second one is to turn the multifunctional utility unit on and off. The multifunctional utility unit is a control and communication unit that can not only be used to interact between the unit and the TV set but also can be used independently.

When the first switch is pressed, the TV screen cover moves from the right to the left. If it turns off, the screen cover will be closed. The cover is used to prevent from the dust. It is made of silk and powered by a small electric motor with other parts. After the utility unit turns on, there are two choices showing on the screen: TV and Multifunctional Utility Unit. If the Multifunctional Utility Unit is selected, the next screen will show all the square items. There are 22 total right now. The user uses the tools (See FIGS. 1 & 2) or the fingers to select the items on the screen. The item that is selected will be responded to the action the user chooses whether it is the item on the TV or on the multifunctional utility unit. The user uses the tools or the fingers to control the flow process.

The items on the TV and the multifunctional utility unit are navigation graphic buttons designed to link to the different functions and applications. The user taps them to activate them. If the switch of the utility unit turns off, both the TV and the utility unit turn off. Otherwise the OFF button on each of them will control the turn off function.

The multifunctional utility unit has two pairs of holders. See FIG. 4 for demonstration. They can be put down, withdrawn and taken off The holders are designed to raise height so that the user can use the unit comfortably when operating. The tapping tool will be attached to the back of the unit. The second tool set will be used for typing. The utility unit has a flat screen with a cover. It also has a strap built for carrying the unit. A tripod also comes with the unit to support it if it is used outdoor. There are microphones and speakers built in the unit and the TV.

On the back of the TV, there is a pair of hooks that are used for hanging the TV set up on the wall. There is another holder to hold the TV if it is set on the surface. On the top of the TV there is a pair of built-in holders for carrying the TV set whether the user wants to fold it or not. If the TV set is small, there is only one holder. The screen can be taken out by releasing the lock handles on both sides. Related wires can be unattached at the back of the screen. The back parts behind the screen contain hardware, mother board, other circuit boards, speakers, drive and other components. They are arranged and put separately on either the left or the right side of the TV. In the middle there are a couple of hinges are installed to help fold the unit.

A pair of outdoor tripod holders to support the TV set comes with the TV set. The height of the holders can be adjusted so that the TV set can be set to the user's height expectation. Another accessory is the shade which can be attached on the top of the TV set to shield off the light.

### BACKGROUND OF THE INVENTION

Most TV sets have been exclusively used for showing TV programs on TV nowadays weather it shows movie, sports or other entertainment programs. Rarely it is used for other purposes although internet capability has been added as a new function lately. An outdoor television set designed for outdoor usually refers to those in the outdoor sections of bars, sports fields, or other community facilities. Most remote controls used at home are traditional and limited to only a few functions.

The next generation multifunctional TV set with the multifunction digital utility unit adds many other functions and applications so that both of them can be used for multi purposes. Moreover the next generation TV can be watched both at home and outdoor. It can be carried and watched outdoor whether it is close to or far away from home. The screens are designed to remain clearly visible even in outdoor lighting. The screens will also have anti-reflective coatings to prevent glare. They are weather-resistant. Besides the multifunctional utility unit that comes with the TV can do as many things as the TV can. It is different from the remote control that we are using now.

According to Quarterly TV Design and Features Report, TV manufacturers will ship over 118 million internet connected TV's in 2014. This is a rise from the estimated 40 million this year, which in turn was up from around 15 million in 2009. The next generation TV will be high end and expensive. It will target the limited market.

### TECHNICAL FIELD

The present invention relates to the multifunctional next generation TV set. More particularly, the present invention relates to both the multifunctional next generation TV set and the multifunctional utility unit that are capable of processing multiple tasks. The following paragraphs will technically describe the major items and the layout.

The television set comprises a display, radio frequency (RF) input (a TV aerial plug or an F connector), and a digital tuner. The digital tuner in a display device receives and distinguishes the signals and check if they are processed. If they are successful, the signals will be transformed and shown on the screen. The television uses different technical standards. In this case, high-definition television (HDTV) using LCD, Plasma or DLP will apply on the TV set. The TV set comes with speakers and other internal electronic circuits. Its screen uses display device (CRT, Cathode Ray Tube) to show the image. It offers a flatter screen, reducing problems with glare. It can get a 16:9 aspect ratio.

To construct the CRT, the screen and envelope glass pieces need to be molded separately and then glued together as one of the last steps of assembly prior the baking and evacuation. The shadow mask behind the screen is manufactured through a photo etching process. Each shadow mask is unique for its faceplate. They are not interchangeable. Following are the other related construction steps:
For each of the phosphor colors, one phosphor layer is deposited followed by one photo resist layer.
The shadow mask for that CRT is then mounted - clicked in place.
An intense point source of light is mounted at the location of the effective center of deflection for the electron gun associated with that phosphor.
The photo resist is exposed to light.
The shadow mask is removed and the excess resist and phosphor is washed away.

These steps are repeated for the red, green, and blue phosphors and the optional black matrix surround.

Then, an aluminum overcoat is deposited over the phosphor/black matrix. This has several functions:
Provide the return path for the electron beam—connected to the EHT 2nd anode.
Reduces backscattering or secondary emission. Electrons that bounce back from either the shadow mask or the screen may hit a phosphor elsewhere and thus cause unwanted white light. That reduces contrast and color purity.
A side benefit is that it blocks negative ions from residual air molecules from hitting the phosphors. These might result in an unsightly blemish in the center of the screen since they are much heavier than electrons and are not deflected very much.

The shadow mask is then mounted for a final time and the faceplate, envelope are mated. At this point, it is ready for the final baking and evacuation.

The tube is evacuated through the thin stem that is located in the middle of the socket. That takes several hours at the vacuum pumps. The stem is then sealed by heating and melting.

The getter —part of the electron gun assembly—is then ‘activated’ via induction heating from a coil external to the next of the CRT. This vaporizes and deposits a highly active metal on the interior of the glass of the neck. The getter material adsorbs much of any remaining gas molecules left over from the evacuation of the tube.

When the tube is ready it is matched with a deflection coil that provides optimum purity. It takes some ingenuity to get a good match between using a light for exposure which matches the behavior of the future electron optical system, in order to get good purity.

Once the CRT is sealed, baked, evacuated, etc., the job is not yet done. They still need to match the finished tube with a deflection coil that will give adequate purity performance and then they need to fiddle with magnets to improve it further. And even then many tubes need active correction for convergence and/or geometry.

The TV set parts and components will be built on the right side of the screen if it is seen from the front.

The cell phone operates within cells. It uses two frequencies per call. It can switch cells as it moves around. Cells give cell phones incredible range. The cells phone can communicate with each other for long distance even driving hundreds of miles and maintaining a conversation the entire time because of the cellular approach.

The cell phone will be built in the multifunctional utility unit. There is another phone built in the TV set. The user can make and receive phone calls on the multifunctional utility unit. The TV phone will be operated like a family phone. The handset will be hooked on the side of the TV set. There is port for connecting the phone jack.

The cell phone has low-power transmitters in it. It usually has two signal strengths: 0.6 watts and 3 watts (for comparison, most CB radios transmit at 4 watts). The base station is also transmitting at low power. Low-power transmitters have two advantages: The transmissions of a base station and the phones within its cell do not make it very far outside that cell. Therefore, both of the purple cells can reuse the same frequencies. The power consumption of the cell phone, which is normally battery-operated, is relatively low. Low power means small battery

The cell phone has special code associated with it. The code is used to identify the phone. When the phone turns on, it listens for an SID on the control channel. The control channel is a special frequency that the phone and base station use to talk to one another. If the phone cannot find any control channels to listen to, it knows it is out of range and displays a “no service” message. When it receives the SID, the phone compares it to the SID programmed into the phone. If the SIDs match, the phone knows that the cell it is communicating with is part of its system.

The cell phone will be installed in the multifunctional utility unit. The parts and components will be built at the left side of the unit if the unit is seen from the front. The parts and components of the TV phone will be built at the right side of the TV set if it is seen from the front.

The radio will be built with a couple of electronic components: radio transmitters and receivers. The transmitter takes some sort of message encoding it onto a sine wave and transmits it with radio waves. The message could be the sound of someone's voice, pictures for a TV set, and data for a radio modem. The receiver receives the radio waves and decodes the message from the sine wave it receives. Both the transmitter and receiver use built in antennas to radiate and capture the radio signal.

There are two radios. One is built in the multifunctional utility unit. The other one is in the TV set. Both parts and components will be put at the left sides. AM and FM channel information will be displayed in the middle of the screens.

The computer is divided up into two main categories: the brains and the guts. The brains of the computer include all the elements that allow the computer to process data. The guts include all the other elements that make computers useful, but aren't directly involved in computing information.

The base of operations for the brains of a computer is the motherboard. The motherboard serves as a literal foundation for many of the other elements inside the computer. It's a printed circuit board. The motherboard provides the connections and sockets that let other components communicate with each other. Motherboards come in different shapes and sizes.

The brain is a microprocessor called the central processing unit (CPU). The CPU is a chip containing millions of tiny transistors. It's the CPU's job to perform the calculations necessary to make the computer work—the transistors in the CPU manipulate the data.

Another critical component in the computer is memory. The two most important kinds of memory are read-only memory (ROM) and random access memory (RAM). Computers can read data stored in ROM, but can't write new data to it. With RAM, computers can read from and write to that memory.

A chip called the Basic Input/Output System (BIOS) works closely with the CPU. BIOS is a specific kind of ROM. It might be considered to be the spine of the computer. It's the job of BIOS to handle interactions between the software running on a computer and the machine's hardware components. The motherboard, CPU, ROM, RAM and BIOS handle most computer processes. They also accept input from devices like keyboards, mice and other computer accessories.

The shape and layout of a motherboard is called the form factor. The form factor affects where individual components go and the shape of the computer's case. It is one of the many standards that apply to motherboards, which includes: 1). the socket for the microprocessor determines what kind of Central Processing Unit (CPU) the motherboard uses. 2). the chipset is part of the motherboard's logic system and is usually made of two parts—the northbridge and the southbridge. These two “bridges” connect the CPU to other parts of the computer. 3). the Basic Input/Output System (BIOS) chip controls the most basic functions of the computer and performs a self-test every time you turn it on. Some systems feature dual BIOS, which provides a backup in case one fails or in case of error during updating. 4). the real time clock chip is a battery-operated chip that maintains basic settings and the system time.

The slots and ports on a motherboard include: Peripheral Component Interconnect (PCI)—connections for video, sound and video capture cards, as well as network cards ;Accelerated Graphics Port (AGP)—dedicated port for video cards; Integrated Drive Electronics (IDE)—interfaces for the hard drives; Universal Serial Bus or FireWire—external peripherals and Memory slots.

Redundant Array of Independent Discs (RAID) controllers allow the computer to recognize multiple drives as one drive. PCI Express is a newer protocol that acts more like a network than a bus. It can eliminate the need for other ports, including the AGP port. Rather than relying on plug-in cards, some motherboards have on-board sound, networking, video or other peripheral support.

There are two computers that will be built. One is for the multifunctional utility unit. The other is for the TV set. The parts and components as described will be installed at the right side of the screen if they are seen from the front.

The camera records images electronically. A digital image is just a long string of 1s and 0s that represent all the tiny colored dots—or pixels—that collectively make up the image. It has a series of lenses that focus light to create an image of a scene. But instead of focusing this light onto a piece of film, it focuses it onto a semiconductor device that records light electronically. An internal process then breaks this electronic information down into digital data. The amount of detail that the camera can capture is called the resolution, and it is measured in pixels. The more pixels a camera has the more detail it can capture and the larger pictures can be without becoming blurry or “grainy.”

In order to get a full color image, most sensors use filtering to look at the light in its three primary colors (Red, Blue and Green). Once the camera records all three colors, it combines them to create the full spectrum. The cameras use three separate sensors, each with a different filter. A beam splitter directs light to the different sensors. Each sensor gets an identical look at the image; but because of the filters, each sensor only responds to one of the primary colors. The advantage of this method is that the camera records each of the three colors at each pixel location.

The camera has the function of exposure and focus to control the amount of light that reaches the sensor. There are two components it uses to do this, the aperture and shutter speed. Aperture: The size of the opening in the camera to control over the final image. Shutter speed: The amount of time that light can pass through the aperture. Unlike film, the light sensor in the camera can be reset electronically, so it has a digital shutter rather than a mechanical shutter.

In addition to controlling the amount of light, the camera has to adjust the lenses to control how the light is focused on the sensor. The focal length is the distance between the lens and the surface of the sensor. The sensor is smaller than a piece of 35 mm film. In order to project the image onto a smaller sensor, the focal length is shortened by the same proportion. Focal length also determines the magnification, or zoom. Increasing the focal length increases the magnification, and objects appear to get closer. The reverse happens when decreasing the focal length. A zoom lens is any lens that has an adjustable focal length. The camera will have both optical and digital zoom. Optical-zoom lenses with automatic focus—Similar to the lens on a video camcorder; these have “wide” and “telephoto” options and automatic focus. The camera may support manual focus. These actually change the focal length of the lens rather than just magnifying the information that hits the sensor. Digital zoom—With digital zoom, the camera takes pixels from the center of the image sensor and interpolates them to make a full-sized image.

There are two built-in cameras in the TV set. One is at the up middle part. The other is at the low middle part. They are built for video conversation. Another camera at the up left corner is for monitoring purpose. The camera in the multifunctional utility unit will be installed on the top edge side. It is for taking pictures. There is another camera in the multifunctional utility unit for video conversation.

The elements put into a projector headlamp are a light bulb, projector, shield and reflector. The ellipsoidal reflector has filament on one end and a condenser lens on the other. The condenser lens is connected to the front of the lamp. Between the reflector and the lens is a shade that is located at the image plane. As the light from the bulbs is projected, the shade provides a cutoff for the low beam. The shade is shaped and positioned in such a way that the sharpness of the light is controlled. It is also because of the shade that the light gives off a soft blue hue.

Other functions of the projector will be: 1). compression—it will convert one form of pixelated input into another. For example a computer might put out XGA and the projector might convert it to SVGA. This makes the projector more versatile; 2). contrast—the ratio between darkness and brightness, contrast determines the clarity of images, especially letters and other symbols on a page. Typical contrast runs from 400:1 to 800:1 and more; 3). distribution amplifier—this will amplify or increase a source signal and distribute it over significant distances, through multiple outputs. This can be important, as signals that are sent over cheap cables at ranges above just a few feet can be intermittent or even non-existent; 4). DLP (Digital Light Processing)—it uses tiny mirrors (480,000 to over a million mirrors in a single small space) to display an image on a screen. This allows for deeper and more varied colors to be used; 5). focus—light and images coming out of the lens are concentrated to make clear, discernable images on the screen. The lens can only focus within certain parameters or distances so this will limit how far a projector can be from a screen as well as the size of the projection; 6). keystone—when the image is bigger at top than the bottom this is called a keystone. LCD (Liquid Crystal Display)—uses electric current to align crystals suspended in a liquid. Because the rod-shaped crystals are contained between two parallel transparent electrodes, when a current is applied, they can change their orientation, creating varying degrees of color. Three colors and their shades are necessary to produce any color in the spectrum. 7). Lumens—This is a measure of the amount of light streaming out of the projector. More lumens will be necessary to light spaces with more ambient light. At least 1500 lumens are considered necessary for projectors used in auditoriums and bright rooms. Pixel A pixel is a small dot of light that forms a part of the display of an image. On a computer screen, clarity can be defined as the number of pixels per square inch (resolution). The more pixels, the higher the definition possible, but also the larger the files must be to contain the image; 8). resolution—the number of dots a display uses to create an image. These dots are called pixels. The more pixels per screen area the sharper the display will be; 9). throw distance—the distance from the center of a projector lens measured to the center of the screen onto which it is projecting.

The projector will be installed on the left side of the camera in the multifunctional utility unit.

The magnetic compass consists of a small, lightweight magnet balanced on a nearly frictionless pivot point. The magnet is called a needle. One end of the needle is often marked “N,” for north. On the surface it is a compass. The compass device will be installed at the top left sides of the multifunctional utility unit and the TV set.

The digital voice recorder records speech and other sounds by the receiver. It converts sound into a digital signal that can be stored by the recorder. The digital voice recorder takes a series of samples of the sound. The higher the sampling rate is, the more accurate the reproduction of the original sound will be. Compression, on the other hand, works to reduce file sizes by getting rid of some data. Highly compressed files using DSS or LPEC file formats are significantly smaller than other file formats. The digital voice recorder has on-board memory. It has plenty of memory for hours of recording. It records from 44 KHz sampling rate up to 96 KHz. The recorder has external microphone to enhance sound quality and limit noise on outdoor recordings. The recorder comes with other managing and edit features such as categorizing, delete and plays back etc. It is compatible with the computer. The files on the recorder can be transferred, back played and managed on the computer supported by the customized software. The digital recorder will be installed at the up right side of the multifunctional utility unit.

CCTV stands for Closed Circuit TV. CCTV uses two video cameras to transmit video and audio images to a monitor, or video recorder. CCTV is not openly transmitted to the public. CCTV uses wireless transmission to send the broadcast from the video cameras to the monitor or video recorder. The CCTV within the TV set is used for surveillance which can include security monitoring, spying or for safety monitoring purposes. The CCTV cameras take color video images. It has night vision capabilities which allow the camera to view and record low light images.

The camera allows a person controlling the surveillance of an area to move the camera remotely, usually with an RF or wired controller. The cameras allow the person monitoring it to move the camera from right to left (pan), up and down (tilt) and from a tight angle to a wide angle.

The camera is wireless using the 2.4 Gigahertz frequencies to transmit their video images to a monitor or video recorder. The wireless camera can easily transmit the frequencies through most walls and obstacles; the wireless CCTV cameras can send data to a range of about 200 feet.

There are two main ways to record video images that the CCTV camera captures; they are analog tape and digital video recorders. If using the digital video recorder, it can either be stand alone devices or hard drives that are connected to a computer system. DVR's work similar to VCR's except the images it captures from the camera is digital. The CCTV camera will be installed at the top left side of the TV set.

The GPS receives the signals from the satellites. Each GPS satellite transmits data that indicates its location and the current time. All GPS satellites synchronize operations so that these repeating signals are transmitted at the same instant. The distance to the GPS satellites can be determined by estimating the amount of time it takes for their signals to reach the receiver. When the receiver estimates the distance to at least four GPS satellites, it can calculate its position in three dimensions. For the initial position calculation the GPS chipset finds at least 4 satellites with a strong enough signal (28 dBHz or more) and it must keep those satellites and the signal strength for approximately one minute in order that it can download the data from the satellites that is essential for calculating your position. Once the receiver makes the calculation, it tells the latitude, longitude and altitude of its current position. If at any time the GPS receiver loses the signal of any satellite or the signal drops below 28 dBHz then it has to start all over again and track that satellite for another minute.

Besides deciding the location, GPS also helps get somewhere. To make the navigation more user-friendly, the GPS plug the raw data into map files stored in memory. It provides information with traffic signs, prohibited manoeuvres, vehicle restrictions, post/zip codes, house number ranges, points of interest, tourist information, speed camera data, route calculation, route guidance and much more. Maps are updated to reflect changes in the real world as soon as possible after they occur. The GPS will be installed at the right side of the multifunctional utility.

Blu-ray (not Blue-ray) also known as Blu-ray Disc (BD), is the name of a new optical disc format. The format was developed to enable recording, rewriting and playback of high-definition video (HD), as well as storing large amounts of data. The format offers more than five times the storage capacity of traditional DVDs and can hold up to 25 GB on a single-layer disc and 50 GB on a dual-layer disc. This extra capacity combined with the use of advanced video and audio codes will offer consumers an unprecedented HD experience. The next generation TV supports Blu-ray and most other formats. It is installed at the left side of the TV.

The basic karaoke equipment consists of a music player, microphone and inputs, pitch button controls and audio output. Most karaoke machines also have built-in audio mixer capability. A public address system is often referred to as a PA system. It is an electronic amplification system that consists of an amplifier, a mixer, and loud speakers to emphasize sounds that stem from prerecorded music, a person speaking, or a message, with the purpose of sharing the sound or message in an amplified (loud) manner so that everyone can clearly hear the message being relayed. CD+G players have a unique feature referred to as a sub-code. The sub-code encodes the lyrics and pictures displayed on the screen. Other components are configured to display not only audio but video as well. The karaoke machine is designed with technology that allows the pitch of the music to automatically change and adjust to the amateur singer's vocal range allowing the user to be able to single to just about any music selected and yet still retain the original rhythm of the song. The karaoke machine will be installed at the right bottom side.

There are programs built and uploaded into the utility unit and the TV set. There are different module programs compiled and intended for different purposes. The module programs are built using different development tools. They are written and stored in different locations.

### BRIEF DESCRIPTION OF THE DRAWINGS

FIG. 1, shows the accessory tapping tool used for the multifunctional utility unit.

FIG. 2, shows the accessory tool for typing on the multifunctional utility unit.

FIG. 3, shows the multifunctional utility unit if it sits on the surface with the pair of holders pulled down.

FIG. 4, shows the back of the multifunctional utility unit.

FIG. 5, shows the cover and the strap built for the multifunctional utility unit.

FIG. 6, shows the carrying holders and shade on the top of the TV set.

FIG. 7, demonstrates how the TV set folds after releasing the panel screen.

FIG. 8, demonstrates how the panel screen can be taken out from the TV set.

FIG.9, shows the screen cover for the TV set and other parts including a motor.

Now refers to the figures:

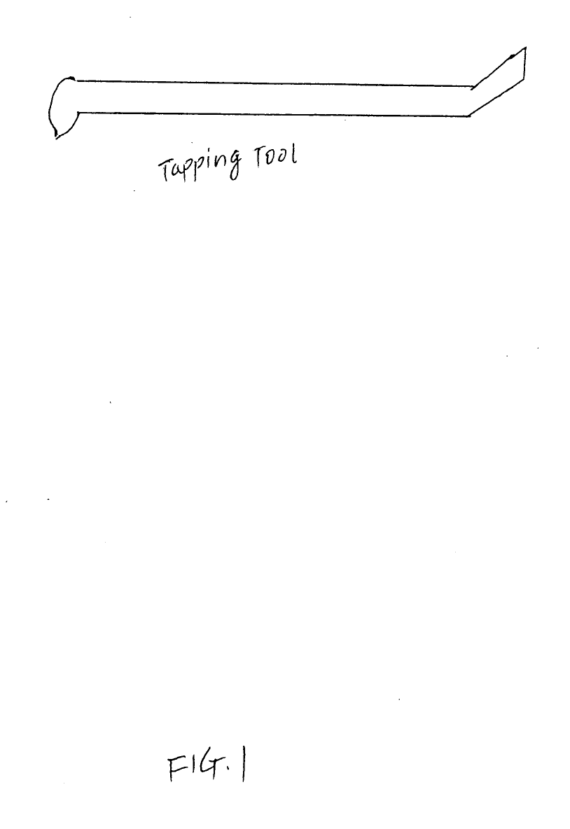

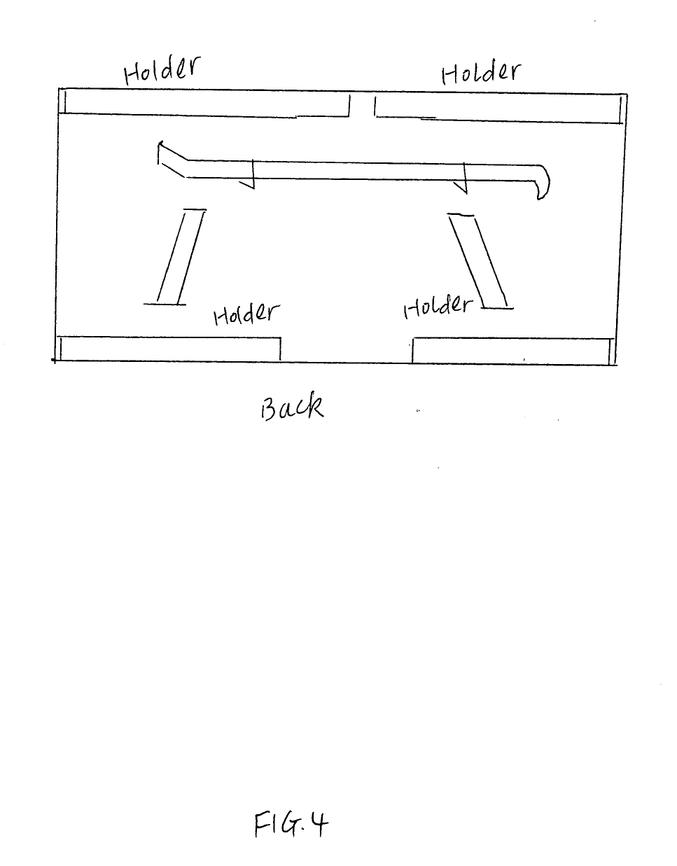

FIG. 1 is the tapping tool used for the multifunctional utility unit to control the process or type. It is made of steel inside with plastic wrapped. On one end of the tool there is curve designed for easy holding. The other end has a round head shape with sharp point for easy locating the positions on the utility unit. The length of this tool depends on how large the utility unit is. There are 5″, 6″ and 7″ three sizes. It is about 0.25″ wide. The tool is placed in the hook device at the back of the utility unit (See FIG. 4).

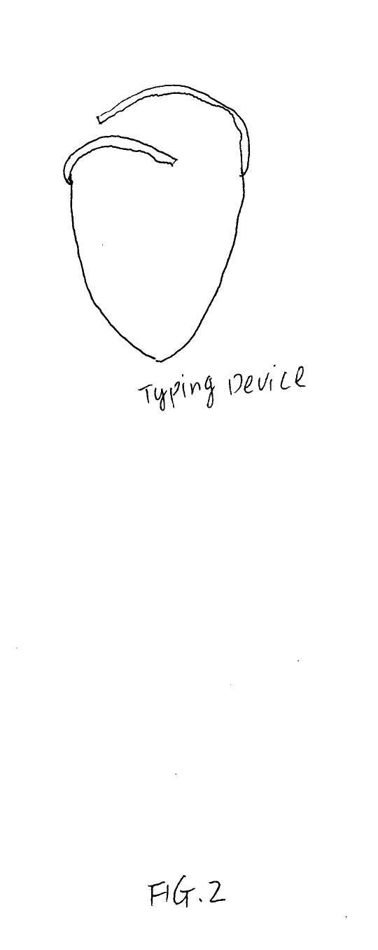

FIG. 2, this is another tool set coming with the utility unit. There are ten pieces altogether designed with sharp ends for typing purpose. There is a pair of straps at the end. The tool can be put on the fingers and tightened with the straps. They are made of plastics and resilient.

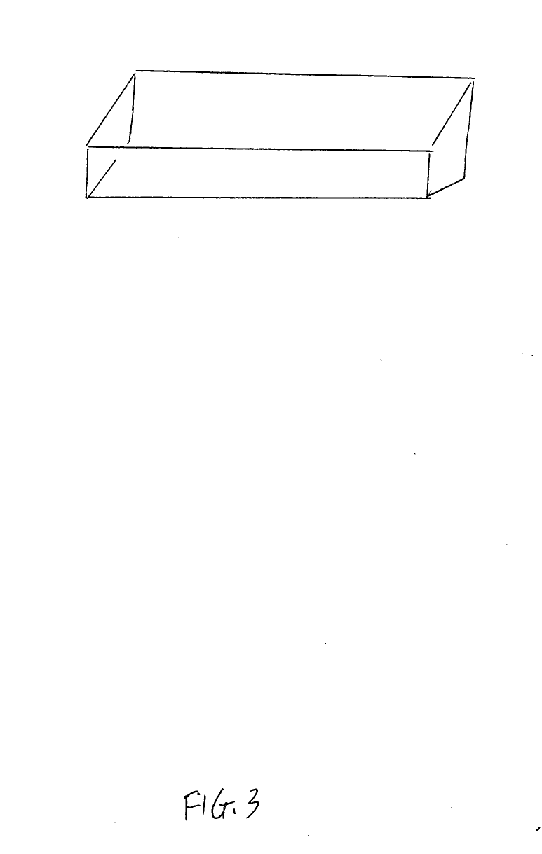

FIG. 3 shows the utility unit sits on the surface when the supporting pairs of holders are pulled down. The pair on the top is made longer than the bottom pair. The height of both pairs can be adjusted. They can be taken off (Also see FIG.4).

FIG. 4 shows the back of the multifunctional utility unit. On the back of the unit there are two pairs of supporting holders (as explained in FIG.3). There is a slot for storing the tapping tool. There is another pair of incline holders that can be pulled down to support the unit on the surface.

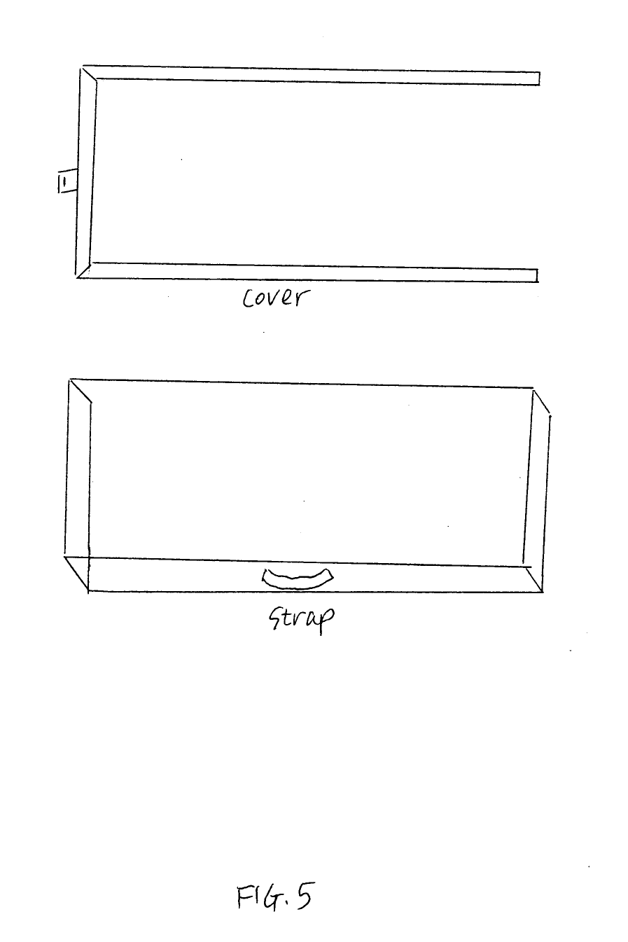

FIG. 5 shows the cover and strap built for the utility unit. The cover is a piece of flat plastic sheet with lock device at the left middle center. At the left center of the unit there is small port with a little mouth under it designed for the lock device. Once the device is pushed in, it is locked. If it is pushed from the little mouth and lifted, the cover is released. The carrying strap is built at the bottom of the unit.

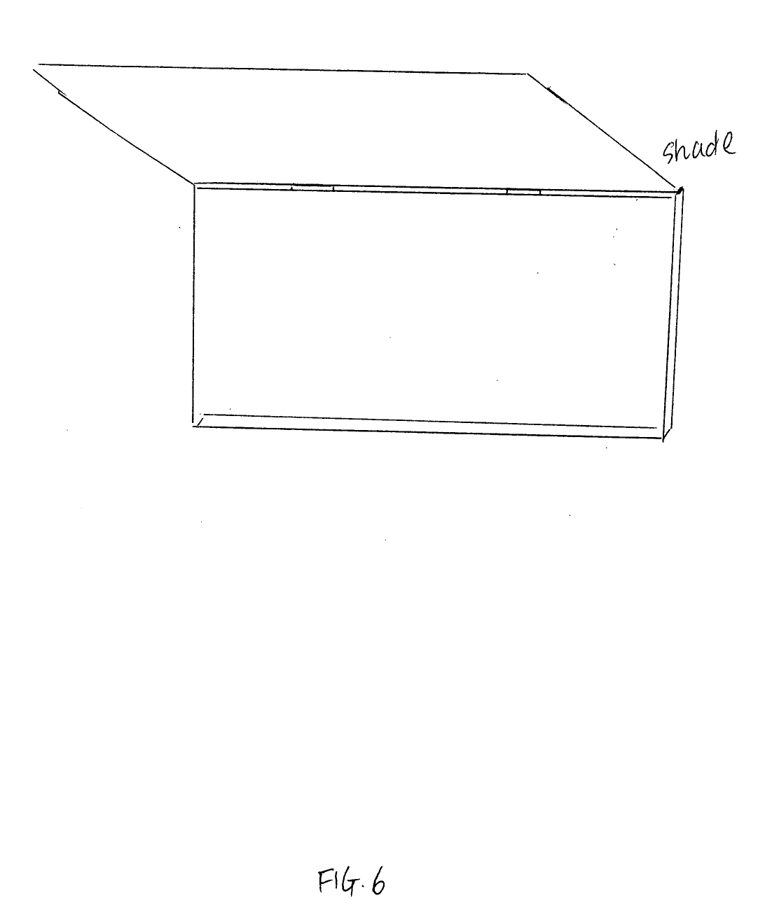

FIG. 6 shows how the shielding shade is attached on the top of the TV set. On the top of the TV there is a built-in slot for inserting the shade. Once it is inserted, it will stay there. The shade can be folded or stretched out. If it is folded down, it can be used as the screen cover. The shade is made of soft textile material.

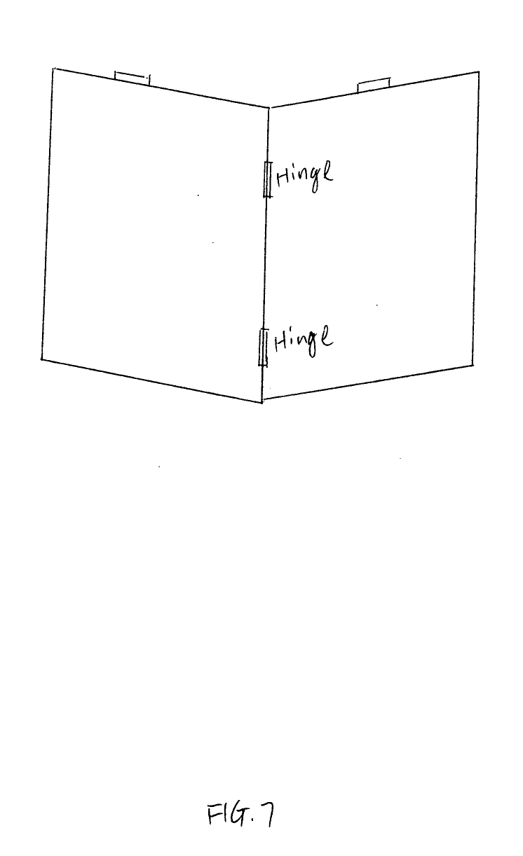

FIG. 7 demonstrates how the TV set is folded. There are two hinges that are built in the middle to hinge the two parts of the TV set.

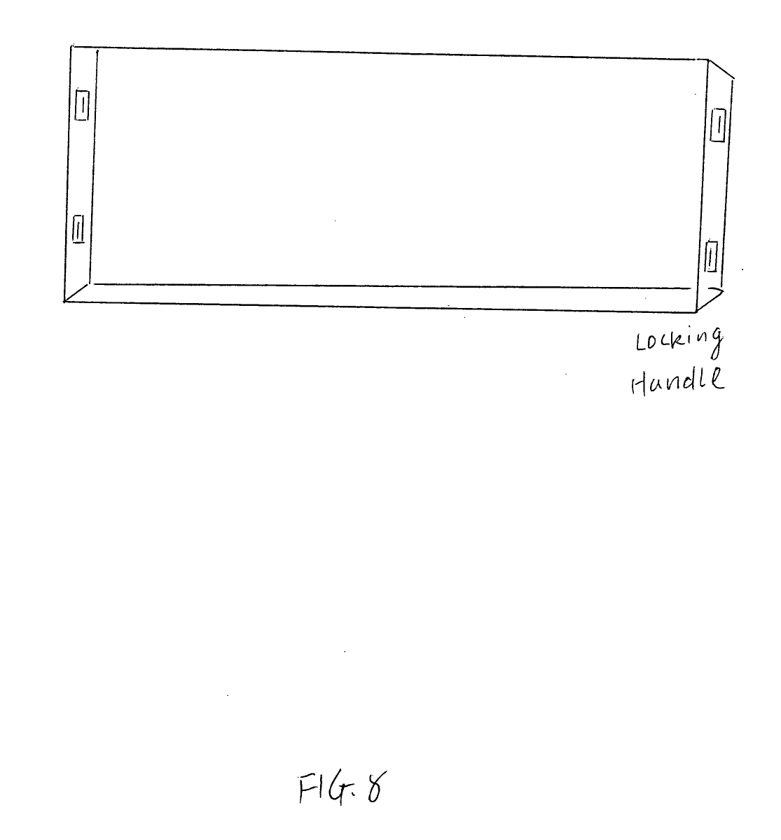

FIG. 8 shows the lock device locking the panel screen. There are two lock devices on each side of the TV set to lock the panel screen. If the lock handle device is pulled down, the hook inside the TV set is released. The panel screen can be taken out with un-attaching the wires.

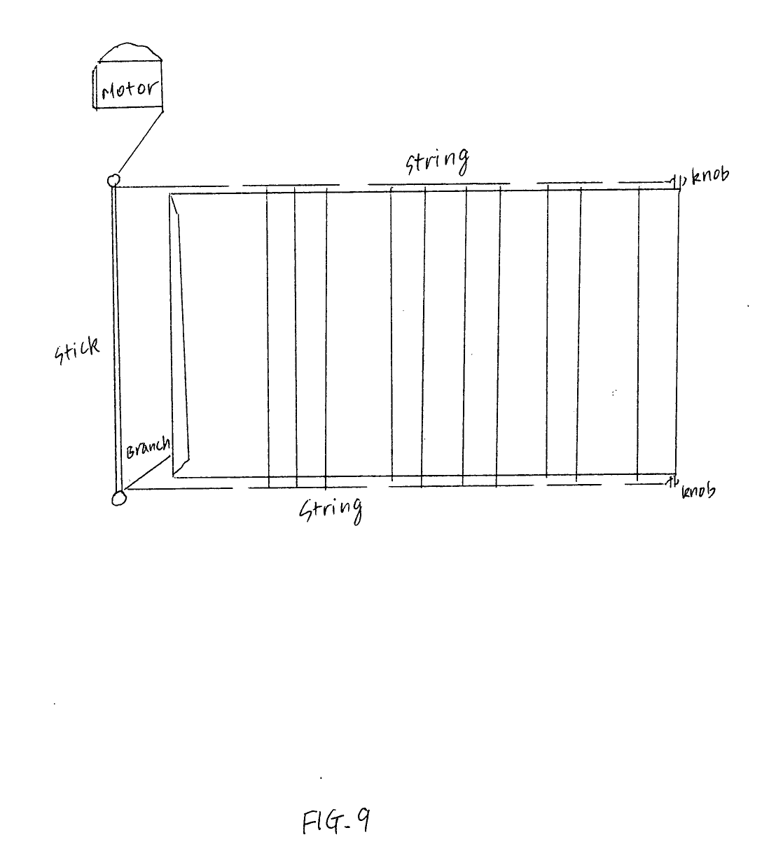

FIG. 9 shows how the screen cover works. The screen cover is powered by a small electric motor. It can be mounted close to the TV on the wall. The cover is a piece of silk with holes on the top and the bottom. The steel strings go through the holes. Two holes at the ends of the strings are made to hook on the small knobs on the right side corners of the TV. There is a thin stick bar made of plastic with hole. It needs to be inserted onto a stick with the branch attached at the rear bottom part of the TV. If the end of the branch is pushed into the connector and turns at the left bottom part of the TV set, the whole piece will be locked. If it is pushed again and turns the other way, it is released. A durable string is hooked on the stick bar with the motor. When the motor turns on, the stick bar rolls and the screen cover moves from the right to the left. When the motor switch is pushed again, the screen cover will be closed.

The multifunctional utility unit is made up with different components and parts. The purpose of making the unit is not only connecting the unit with the TV set but also using the applications itself The screen of the multifunctional utility unit is made flat with crystal glass. The major parts and components associated with the applications of the unit are spread and put at the designated design area in the utility unit. The smallest unit is about 10″ long, 8″ wide and 2-3″ thick. On the top there are a built-in camera and projector. The lenses are installed on the top edge side. There is also another camera in the middle of the screen for video conversation. On the top right edge side there are two switches. One is for turning on and off the utility unit. The other is for opening and closing the front screen cover for the TV set. The computer parts are put in the middle of the unit. The parts of the digital voice recorder are put at the top right side. The parts for gaming are put down next to the voice recorder. The parts of GPS will be put down next to the game. Two microphones are put at the bottom corners.

The compass device is put at the top left part. The parts for the radio are put next down to the compass. The parts down next to the radio are the cell phone. Two USB ports are put at the up right side. Three slots are built for gaming and camera cards down next to the USB ports. The compass is installed at the left up side. Down next to the compass is the radio. The cell phone parts are installed down next to the radio. The drive will be put at the left bottom side. A camera will be installed for video talk conversation. There is a cover for the unit. A strap is built in for carrying it. The battery charge, ear phone connectors and external volume adjuster are installed at the right bottom. Other parts include the tapping tool, typing tool and supporting holders.

Turn on the multifunctional utility unit, the screen shows two buttons in the middle vertically: TV and Multifunctional Utility Unit. Tapping the Multifunctional Utility Unit displays a new screen with 22 square buttons. The first button on the up right side screen is TV. Clicking TV requires entering the username and password. After the authentication, the screen will show all the TV channels. Watching TV is subscription based, it can be set up through SETUP. The second button is COMPUTERs. If the COMPUTERs is clicked, the screen will show all the computers. The computers can be any one of the desktops, laptops and the computer in the TV set. Choosing one of the computers will show all the items on that computer. Click one of the computer items and follow the process to complete the task. Keyboard will show on the utility unit. The computers can be named and set up through SETUP. The third button is MUSIC. Playing music can either play the music from the drive, the computer or online; Music can be played, uploaded, created, moved and deleted on each device or between. The fourth button is RADIO. Clicking the RADIO shows the channel information in the middle of the screen. Under the channels there are control buttons to control the radio.

The fifth button is WEBSITEs. Clicking the WEBSITEs shows the web address block. Typing an address will go to the website. The multifunctional utility unit will use IE as its default web browser. The sixth button is CALL. Clicking the CALL will show the dialing screen. To make a call the user enters the number and presses the CALL button. Other functions like contacts and call management etc. can be set up here or through the SETUP. The seventh button is GAME. Selecting the GAME will show all the game manufactures. Picking a manufacturer and inserting the game card into the slot will start the game. To stop the game, reject the game card from the slot or exit the game from the screen. The eighth button is MOVIE. Clicking the MOVIE shows two options. The first option is to watch the movie from the drive. The second option is to watch the movie from the internet. If the second option is the choice, it will show all the sites under the button where movies can be watched. Watching movie can be set up from SETUP. The ninth button is CAMERA. Selecting the CAMERA, the camera cover opens and the screen for controlling the camera shows. To take a picture press the shoot button, to adjust the distance press the zoom button. Other functions like pictures management etc can be set up here or from SETUP. The tenth button is VOICE RECORDER. Clicking the VOICE RECORDER the screen shows all the control buttons which include record, stop, save and erase etc.

The eleventh button is GPS. Clicking the GPS shows the navigation screen, the built-in software will guide to use the GPS. A slot can be used to insert the map card. The map can also be down-loaded and updated from the internet. The twelfth button is PRINTER. Clicking the PRINTER shows all the connected computers. Picking a computer and choosing the material to be printed will start to print. Printer can be set up here or from the SETUP. If setting up is from here, the set up button will be put under the COMPUTERs. The thirteenth button is COMPASS. Clicking the COMPASS will show where the north points. To go back, click the up arrow to the main screen. The fourteenth button is DISPLAY. Displaying is to display the clock, calendar or pictures from any storage. If the clock is clicked, different designs of the clock appear on the screen. The user picks one. The clock will appear on the screen. If the calendar is selected, different designs of the calendar appear on the screen. The user picks one. The calendar will show on the screen. If the user wants to display a picture, the user goes to the file and picks one. The picture will show on the screen.

The next button (The fifteenth button) is PROJECTOR. The cover will open after it is clicked. The computers will show on the screen. The file directory tree also shows on the screen if the computer is clicked. The user picks a file and it begins to show. The next button (the sixteenth button) is PLAY DEVICE. The play device includes camcorder and camera. If camcorder is the choice, the user plugs the wire into the unit. The user clicks the start button on the control panel, it begins to show. If camera is the choice, the user inserts the card into the slot on the right side and clicks the start button on the control panel. The pictures start to show on the screen. The next button (the seventeenth button) is VEDIO CONVERSATION. If this button is clicked, the camera opens and it is ready to call and talk. The next button (the eighteenth button) is UPLOAD. There are choices of video, picture, music, movie and file etc. The user picks a choice and connects the external device to the unit. A built-in software program will help upload the contents to the destination file whether it is on the unit or other storage. The next button (the nineteenth button) is SETUP. Under SETUP there are choices of utility unit, TV, computer, cell phone, website, radio, music, camera, and printer. The user can choose the options under each of them. The next button (the twentieth button) is HOME. Clicking HOME, it goes back to the initial screen when the multifunctional utility unit turns on. The next button (the twenty first button) is OFF. If it is clicked, the unit turns off. The next button (the twenty second) is SAVE. If it is clicked, the unit is in save energy mode. There is an up arrow on each sub-screen, if it is clicked; it goes back to the previous screen. Keep clicking will go back to the main screen.

The TV set is made up with different components and parts. The next generation TV set is multifunctional like the multifunctional utility unit. The screen is made flat with crystal glass. The major parts and components associated with the applications of the TV set are spread and put at the designated design area in the TV. The sizes for the TV sets can be different ranging from 20″ up to 100″. The operation of the TV is controlled by the multifunctional utility unit. The panel screen can be taken off by pulling down the lock handle device on both sides (See FIG. 8). The TV set can be folded after the screen is taken out. There are hinges built to connect the two parts of the TV set (See FIG. 7). There are built-in straps for carrying the TV set it is large size. A shielding shade comes with the TV set. It can be inserted into the slot on the top of the TV. The shade can also be used as the screen cover to keep the dust away if it is folded down.

There are three cameras. One is installed at the up middle part; the other is installed at the low middle part. The third one is for CCTV. The first two are used for video conversation and can be adjusted. The TV parts and components are installed in the middle right side part. The computer parts are put next right to the TV. The karaoke is put down next to the computer on the right side. An amplifier is put at the bottom right side. Four speakers are installed at the four corners. Two USB ports are put at the up right side. Two slots are built for camera cards down next to USB ports.

The parts and components for CCTV are installed at the top left side. The parts of the radio are put down next to CCTV. The parts for gaming are installed down next to the radio. And the phone is put next down to the game. The components and parts of Blu-Ray will be installed at the left side next to the TV. Two USB ports are put at the up right side. Three slots that are built for gaming and camera cards are put down next to USB ports. The drive is installed at the right side. There are switch, channel and volume buttons built on the left side of the TV. A telephone and a Ethernet jack are also built on the left side. The telephone handset will be hooked and attached on the left side. Video and audio connectors will be built on the left side.

Turn the second switch on the utility unit on, the TV screen cover moves from the right to the left. Select the TV button from the two buttons on the main screen on the utility unit when it turns on, the TV turns on. There are square buttons showing on the TV. The first button from the up right side is TV. Clicking the TV button shows the default TV channel. On the utility unit control panel shows. The user uses the control panel to navigate the TV. Clicking the up arrow tab will bring up the previous screen with all the square buttons. The second button is COMPUTERs. If the COMPUTERs is clicked, the screen will show all the computers. The computers can be any one of the desktops, laptops or the computer on the multifunctional utility unit. Choosing one of the computers will show all the items on the computer. Click one of the computer items and follow the process to complete the task. Keyboard will show on the multifunctional utility unit. The computers can be named and set up through SETUP. The third button is MUSIC. Playing music can either play the music from the drive, the computer or online; Music can be played, uploaded, created, moved and deleted on each device or between. The fourth button is RADIO. Clicking the RADIO shows the channel information in the middle of the screen. Under the channels there are control buttons to control the radio. The fifth button is WEBSITEs. Clicking the WEBSITEs shows the web address block. Typing an address will go to the website. The unit will use IE as its default web browser.

The sixth button is CALL. Clicking the CALL will show the dialing screen. To make a call the user enters the number and presses the CALL button. Or the user can use the handset attached on the TV. Other functions like contacts and call management etc. can be set up here or through the SETUP. The seventh button is GAME. Selecting the GAME will show all the game manufactures. Picking a manufacturer and inserting the game card into the slot will start the game. The user controls the game from the utility unit. To stop the game, reject the game card from the slot or exit the game from the screen. The eighth button is MOVIE. Clicking the MOVIE shows two options. The first option is to watch the movie from the drive. The second option is to watch the movie from the internet. If the second option is the choice, it will show all the sites under the button where movies can be watched. Watching movie can be set up from SETUP. The ninth button is PRINTER. Clicking the PRINTER shows all the connected computers. Picking a computer and choosing the material to be printed will start to print. Printer can be set up here or from the SETUP. If setting up is from here, the set up button will be put under the computers.

The tenth button is COMPASS. Clicking the COMPASS will show where the north points. To go back, click the up arrow button to the main screen. The eleventh button is DISPLAY. Displaying is to display the clock, calendar or pictures from any storage. If the clock is clicked, different designs of the clock appear on the screen. The user picks one. The clock will appear on the screen. If the calendar is selected, different designs of the calendar appear on the screen. The user picks one. The calendar will show on the screen. If the user wants to display a picture, the user goes to the file and picks one. The picture will show on the screen. The next button (The twelfth button) is PLAY DEVICE. The play device includes camcorder and camera. If camcorder is the choice, the user plugs the wire into the connector on the TV. The user clicks the start button on the control panel, it begins to show. If camera is the choice, the user inserts the card into the slot on the right side of the TV and clicks the start button on the control panel. The pictures start to show on the screen. The next button (the thirteenth button) is VEDIO CONVERSATION. If it is clicked, the camera opens and it is ready to call and talk. The next button (the fourteenth button) is UPLOAD. There are choices of video, picture, music, movie and file etc. The user picks a choice and connects the external device to the unit. A built-in software program will help upload the contents to the destination file whether it is on the unit or other storages. The fifteenth button is CCTV. If it is clicked, it starts to record. CCTV can be set up here or from the SETUP.

The sixteenth button is KARAOKE. Clicking the KARAOKE the drive opens. The user inserts the disc and starts to sing on the multifunctional utility unit. The next one (the seventeenth button) is SETUP. Under SETUP there are choices of TV, computer, telephone, website, radio, music, CCTV and printer. The user can choose the options under each of them and begin to set up. The next one (the eighteenth button) is HOME. Clicking the HOME, it goes back to the initial screen when the utility unit turns on. The next one (the nineteenth button) is OFF. If it is clicked, the TV turns off. The next one (the twentieth) is SAVE. If it is clicked, the unit is in save energy mode. There is an up arrow on each sub-screen, if it is clicked; it goes back to the previous screen. Keep clicking will go back to the main screen.

1. I claim that the multifunction digital utility unit with the next generation multifunctional TV set has the capability of being folded, easy use, carrying and watch TV outdoor.
